(19) United States
(12) Patent Application Publication
(10) Pub. No.: US 2012/0189420 A1
(43) Pub. Date: Jul. 26, 2012

(54) Coupling System for Coupling Loudspeaker Housings, Loudspeaker Housing and Method for Hoisting Loudspeaker Housings

(75) Inventors: Danker Kemper, AN Zwaag (NL); Boudewijn Groen, AN Zwaag (NL)

(73) Assignee: ALCONS AUDIO B.V., Zwaag (NL)

(21) Appl. No.: 13/389,493

(22) PCT Filed: Jul. 8, 2010
(86) PCT No.: PCT/NL10/50437

§ 371 Date: Apr. 10, 2012

(30) Foreign Application Priority Data
Jul. 8, 2009 (NL) 2003153

(51) Int. Cl. B66F 19/00; F16C 11/10; H04R 1/02

(52) U.S. Cl. 414/800; 381/335; 403/84

(57) ABSTRACT

A coupling system (10, 110) comprising coupling means (11, 111) for coupling at least two loudspeaker housings (2, 102) together, designed to couple the loudspeaker housing (2, 102) in such a manner that the loudspeaker housings (2, 102) will extend at a predetermined angle (3, 103) relative to each other in a hoisted position, further comprising setting means (12, 112) for setting said predetermined angle (3, 103), when the loudspeaker housings (2, 112) are in a non-hoisted, stretched position, wherein the coupling system (10, 110) is further designed for coupling the loudspeaker housings (2, 102) in such a manner that said loudspeaker housings (2, 102), upon being moved from the non-hoisted position to the hoisted position, will move under the influence of gravity from the stretched position to the position in which the loudspeaker housings (2, 102) extend at said pre-determined angle (3, 103).

The present invention relates to a coupling system for coupling at least two loudspeaker housings, comprising coupling means designed for coupling the two loudspeaker housings together, which coupling system is designed to couple the loudspeaker housings in such a manner that the loudspeaker housings will extend at a predetermined angle relative to each other in a hoisted position, and which comprises setting means for setting said predetermined angle.

Such a coupling system is known, for example from U.S. Pat. No. 7,262,180, which describes a rigging system for speaker cabinets in a stack, comprising a rectangular bracket, which extends on two sides of a loudspeaker, a rear tie bar which is attached to said bracket and which includes a first pivot attachment point for attachment to a bracket of a second speaker cabinet, a front tie bar which is attached to said bracket and which can be attached to the bracket of the second speaker cabinet, and a lever arm which can be secured to a number of positions on said bracket at one end and which is pivotally attached to said bracket at the other end, which lever arm can be attached to the rear tie bar of a third speaker cabinet, wherein the position of the lever arm on the bracket defines an angle between the first speaker cabinet and the third speaker cabinet.

A drawback of the known system is the fact that the angle between two loudspeaker housings must be set with the loudspeaker housings in a hoisted position, so that forces caused by gravity are exerted on the loudspeaker housings. Said forces may also lead to accidents, for example in that a person's fingers can get jammed between two loudspeaker housings upon setting the aforesaid angle.

It is an object of the invention to provide a coupling system for coupling loudspeaker housings which is reliable and/or efficient, and/or wherein an angle between two loudspeaker housings can be set in a simple and/or efficient manner and/or correctly and/or quickly, and/or wherein the risk of accidents is reduced.

In order to accomplish that object, the coupling system of the kind described in the introduction is according to the invention characterised in that the setting means are designed for setting the predetermined angle when the loudspeaker housings are in a non-hoisted, stretched position, wherein the coupling system is further designed for coupling the loudspeaker housings in such a manner that said loudspeaker housings, upon being moved from the non-hoisted position to the hoisted position, will move under the influence of gravity from the stretched position to the position in which the loudspeaker housings extend at said predetermined angle. An advantage of the coupling system according to the invention is the fact that the predetermined angle is set when the loudspeaker housings are positioned at man height. As a result, no forces caused by gravity are exerted on the loudspeaker housings and/or the risk of accidents is reduced and/or the requirements of the Occupational Health and Safety Act can be complied with. The loudspeaker housings extend in a stretched position while the angle is being set, i.e. at an angle of 0° relative to each other, so that a row of loudspeaker housings does not exhibit the curvature that can be observed when the loudspeaker housings extend at the aforesaid predetermined angle relative to each other. The advantage of moving the loudspeaker housings to the hoisted position after the predetermined angles have been set, during which movement the loudspeaker housings will move relative to each other under the influence of gravity from the stretched position to the position in which the loudspeaker housings extend at said predetermined angle is that less further human interference, if any, is required for moving the loudspeaker housings to the position in which they extend at the aforesaid predetermined angle. As a result, said movement to the hoisted position can take place in a manner which takes little time and/or which reduces the risk of accidents. Another advantage of the coupling system is that the radius of the curve formed by loudspeaker housings between the hoisted, more or less vertical position and the non-hoisted position is smaller than in the known systems. As a result, the row of loudspeaker housings takes up less space upon being hoisted than is the case with the known systems.

In a preferred embodiment of the coupling system according to the invention, the coupling system is further designed for coupling the loudspeaker housings such that said loudspeaker housings can move from the position in which the loudspeaker housings extend at said predetermined angle to the stretched position upon being moved from the hoisted position to the non-hoisted position. This has the vantage that the row of loudspeaker housings will no longer exhibit the curvature while being lowered, so that the loudspeaker housings can be lowered in a safe manner. Another advantage of the coupling system is that the radius of the curve formed by loudspeaker housings between the hoisted, more or less vertical position and the non-hoisted position is smaller than in the known systems. As a result, the row of loudspeaker housings takes up less space upon being lowered than in the known systems.

In another preferred embodiment of the coupling system according to the invention, the coupling means are designed for being movably connected at one end to another end of next coupling means, wherein the setting means comprise retaining means for retaining, in the hoisted position, the coupling means at a position on the other end of the next coupling means which corresponds to the predetermined angle, and wherein the retaining means are designed for retaining the couplings means, at said position on the other end of the next coupling means after rotation of the loudspeaker housings towards and/or away from each other. The coupling means are preferably identical to the next coupling means. The possibility of movably connecting one end of the coupling means to another end of the second coupling means has the advantage that the loudspeaker housings can rotate relative to each other. As a result, the loudspeaker housings can take up a stretched position in the non-hoisted position, after which the loudspeaker housings can rotate relative to each other while being hoisted until the retaining means retain the coupling means at the desired position corresponding to the predetermined angle. An advantage of this is that the retainment of the coupling means takes place under the influence of the hoisting movement, so that human interference is not required.

In another preferred embodiment of the coupling system according to the invention, said next coupling means are provided with a guide at the other end, in which guide a fastening device is movably provided, which fastening device is designed for being connected to one end of the coupling means, and wherein the retaining means are designed for retaining the fastening device at a particular position in the guide corresponding to the predetermined angle in the hoisted position. The guide preferably comprises a keyway, and the fastening device preferably comprises a key, whilst one end of the coupling means preferably comprises at least one opening for receiving the fastening device of the next coupling means. The retaining means preferably comprise at least one opening for receiving the fastening device, which fastening device is retained at a particular position in the guide when it is present in the opening. The loudspeaker housings can rotate relative to each other upon being hoisted up, as a result of which the fastening device or the key is moved in the guide or the keyway until it is positioned over the opening, in which position it will extend into said opening. At that point the fastening device or the key can no longer move freely as a result of being retained and the angular setting between the two loudspeakers is fixed. The advantage of this system is that this can take place in a simple manner without human force being required for rotating the loudspeaker housings.

In another preferred embodiment of the coupling system according to the invention, the retaining means further comprise bounding means for bounding the opening, which bounding means are movable between a first position, in which the opening is not bounded, and a second position, in which the opening is bounded, such that the fastening device, when present in the opening, can move out of the opening in the first position as a result of a force being exerted thereon, whilst it is retained in the opening in the second position. An advantage of a non-bounded opening, from which the fastening device, when present therein, can move out is that in this way the curvature of a row of loudspeaker housings may be minimal during hoisting. An advantage of a bounded opening in which the fastening device is retained is that it makes it possible to connect a row of loudspeaker housings to a cord for suspending the row of loudspeaker housings near both ends of the row without the loudspeaker housings rotating relative to each other, as would be the case if the fastening device would not be retained in the opening. Suspending the row of loudspeaker housings in this manner can be advantageous in the situation in which a relatively long row of a relatively large number of loudspeaker housings exhibiting a relatively large curvature is formed. Preferably, the coupling system further comprises means by which the retaining engagement can at least temporarily be released. This can for example be done by exerting a force on the retaining means in order to push the retaining means aside, such that the fastening device can move out of the opening.

The invention also relates to a loudspeaker housing which is higher at the front side than at the rear side, comprising a recess which continues from the upper side to the bottom side, which recess is located in a centre plane of the loudspeaker housing which extends perpendicularly to the front, rear, upper and bottom sides, in which recess a coupling system is provided for coupling the loudspeaker housing to another identical loudspeaker housing. In the known loudspeaker housings, as for example known from U.S. Pat. No. 7,261,180, the coupling systems may be provided on the sides. The advantage of providing the coupling system in the centre plane of the loudspeaker housing is that only a single coupling system is needed in that case, whilst two coupling systems are needed on the sides. As a result, setting the angle can be done in a simpler manner at a single location. The advantage of this is that time can be saved and that the risk of human error upon setting the angle can be reduced, since it is not possible to erroneously set two different angles on two different sides.

The invention also relates to a loudspeaker housing comprising a coupling system which comprises coupling means for connecting the loudspeaker housing to another identical loudspeaker housing, wherein the coupling means comprise two bodies, wherein the first body is rigidly connected to the loudspeaker housing, comprising a guide in which a fastening device is movably provided, which guide is at least partially arcuate in shape, having a centre which is located at the top or the bottom of the front side of the loudspeaker housing, wherein the fastening device is connected to an end of the second body, wherein the loudspeaker housing or the first body is designed to be connected to the other end of the second body of the other, identical loudspeaker housing, wherein the coupling system comprises setting means for setting a predetermined angle between the loudspeaker housing and the other, identical loudspeaker housing, and wherein the setting means comprise retaining means for retaining the fastening device at a particular position in the guide which corresponds to the predetermined angle. An advantage of using an arcuate guide is that it enables a precise alignment of the angle between the loudspeaker housing and the other, identical loudspeaker housing with the centre, as a result of which the loudspeaker housings precisely abut at their front sides, which is important for acoustic reasons. Another advantage of the arcuate guide and the retaining means is that they make it possible to set any desired angle within the boundaries of the system. Preferably, the first body is rotatably connected to the second body, such that the first body can be disposed substantially in the recess within the envelope of the loudspeaker housing. Alternatively, the second body is preferably movably connected to the first body, such that the second body can be disposed substantially in the recess within the envelope of the loudspeaker housing. This has the advantage that the first and the second body do not extend outside the recess, so that the loudspeaker housings can be transported and/or stored in an efficient manner.

In a preferred embodiment of a loudspeaker housing according to the invention, the first body comprises a second guide, in which a second fastening device is movably provided, wherein the second guide is arcuate in shape, having a centre which is the same as the centre of the first guide, wherein the retaining means are connected to the second fastening device at one end and wherein the retaining means are movably connected to the first body at another end, and wherein the predetermined angle is set by moving the retaining means over the first body. An advantage of connecting the retaining means to the arcuate second guide is that the retaining means are movable about the same centre. The advantage of this is that the system will behave the same with any angular setting.

In another preferred embodiment of a loudspeaker housing according to the invention, the first body comprises a number of openings that correspond to a specific angle between the loudspeaker housing and the other identical loudspeaker housing, wherein the retaining means can be connected to each of said number of openings with one end, such that the position of the retaining means relative to the first body can be adjusted for setting the predetermined angle. An advantage of the use of such openings is that they make it possible to set the predetermined angle in a simple manner. It is noted that the retaining means can be connected either directly or indirectly to the openings.

In another preferred embodiment of a loudspeaker housing according to the invention, the loudspeaker housing comprises connecting means for connecting a loudspeaker housing to the other identical loudspeaker housing in the centre. Because two loudspeaker housings can be connected in the centre, a correct alignment of the two loudspeaker housings can be realised in a simple and/or efficient manner.

The invention also relates to a method for hoisting and lowering loudspeaker housings, comprising the steps of adjusting means for determining an angle between two loudspeaker housings in a hoisted position whilst the loudspeaker housings are in a stretched, non-hoisted position, moving loudspeaker housings between the non-hoisted position and the hoisted position, wherein the loudspeaker housings, upon being moved from the non-hoisted position to the hoisted position, will move relative to each other under the influence of gravity from the stretched position to the position in which the loudspeaker housings extend at the set angle. Preferably, said movement relative to each other from the stretched position to the position in which the loudspeaker housings extend at the set angle takes place as a result of rotation of the loudspeaker housings relative to each other under the influence of gravity. An advantage of said rotation relative to each other under the influence of gravity is that no human force is required for rotating the loudspeaker housings at the correct angle relative to each other. In this way the risk of accidents is reduced.

The invention will now be explained in more detail with reference to figures illustrated in a drawing, in which:

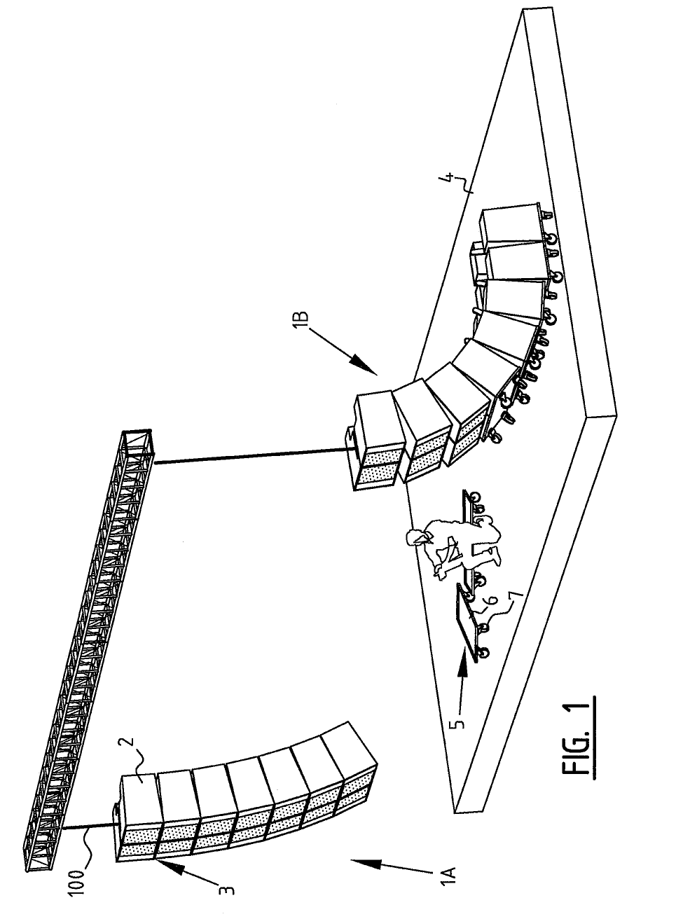

FIG. 1 is a perspective view of a hoisted and a half-hoisted row of loudspeaker housings according to the invention;

FIG. 2 is a perspective view of a loudspeaker housing provided with a coupling system according to a first embodiment of the invention;

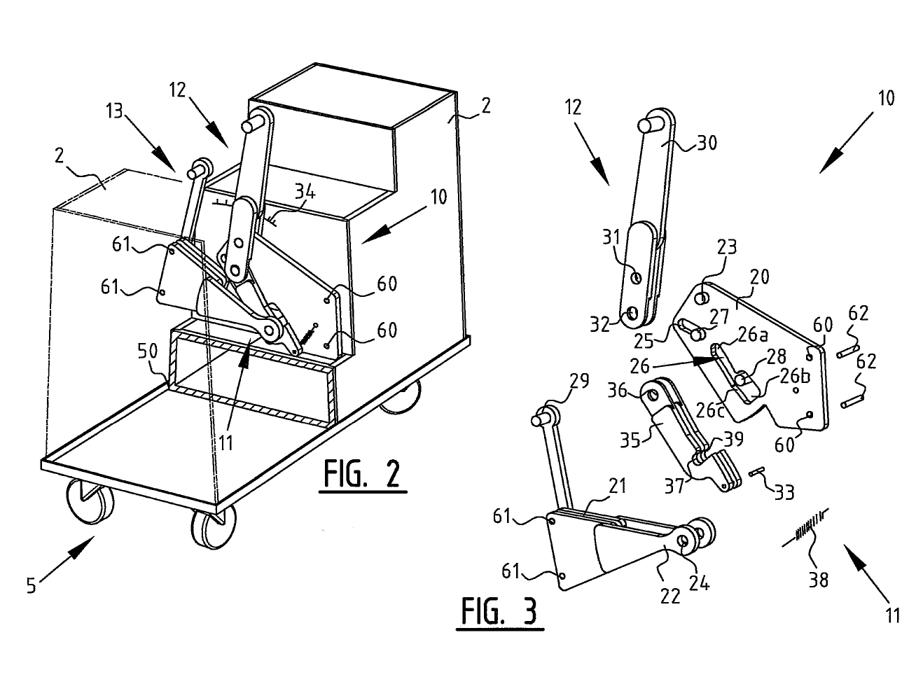

FIG. 3 is a detail view of the coupling system of FIG. 2;

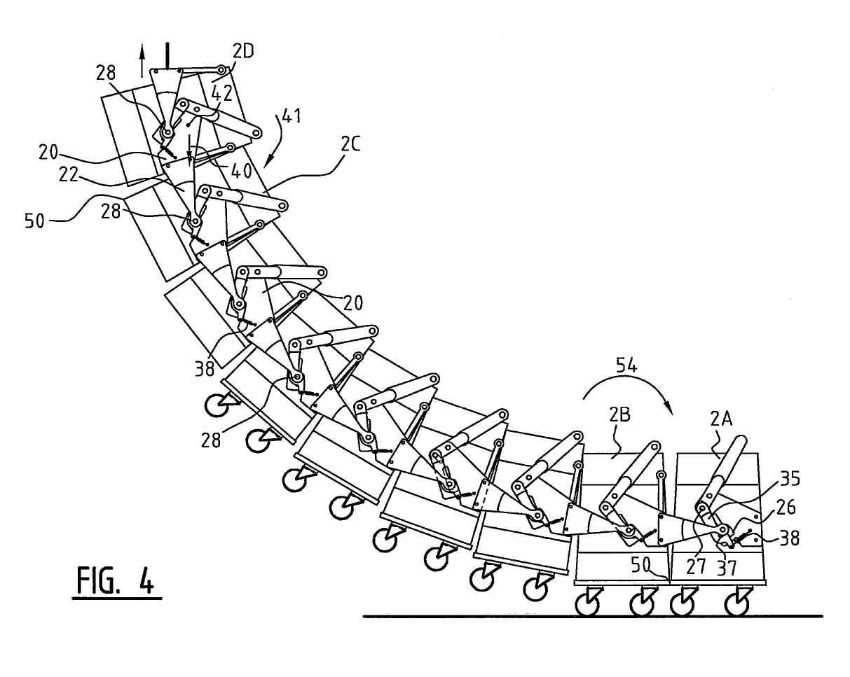

FIG. 4 schematically shows the hoisting of the loudspeaker housings;

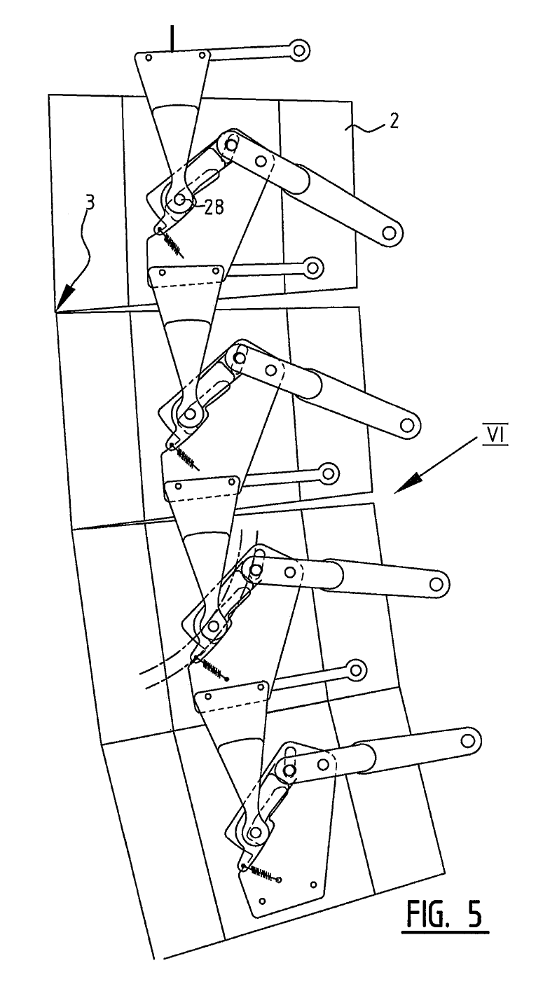

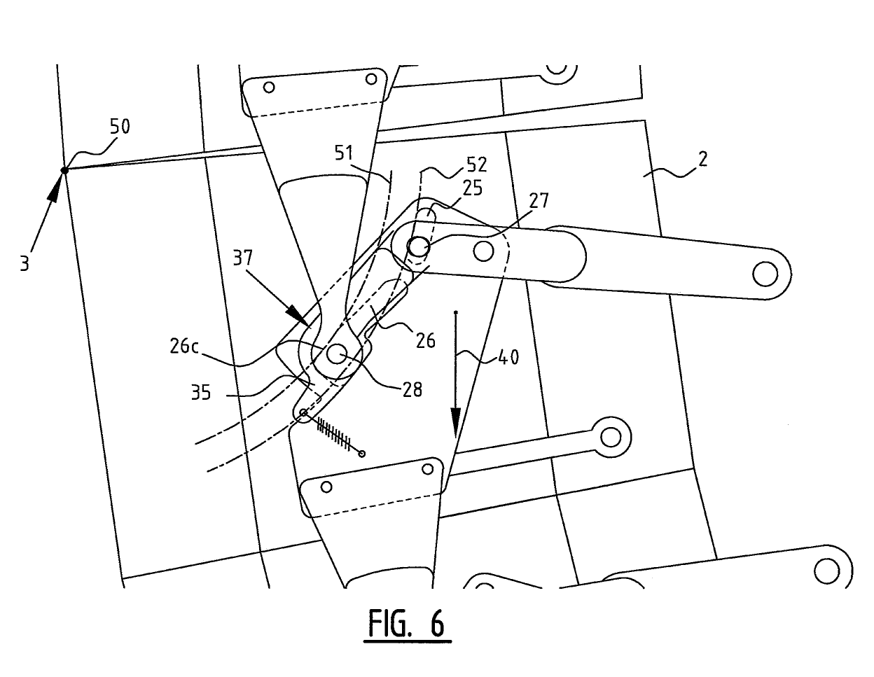

FIG. 5 schematically shows a hoisted row of loudspeaker housings;

FIG. 6 is a detail view of a loudspeaker from the row shown in FIG. 5;

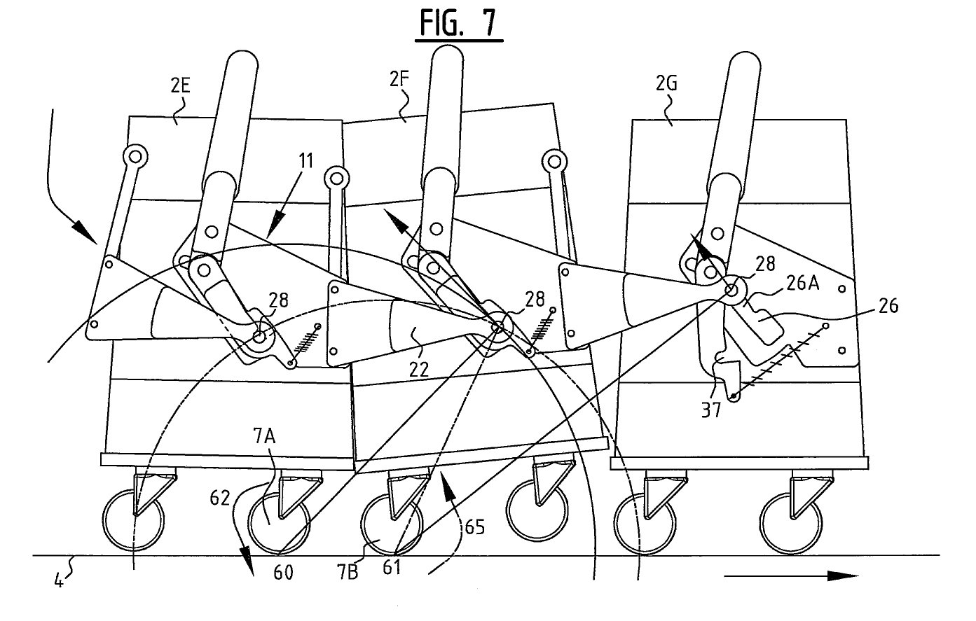

FIG. 7 schematically shows loudspeaker housings being lowered;

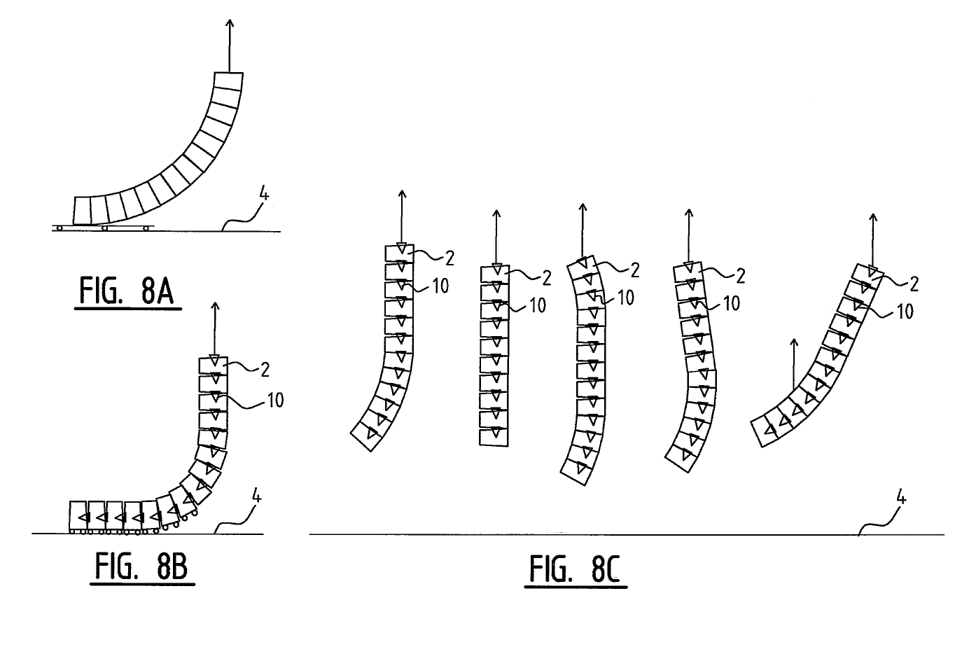

FIG. 8A shows the hoisting of a row of loudspeaker housings according to the known system;

FIG. 8B shows the hoisting of a row of loudspeaker housings according to the invention;

FIG. 8C shows different curvatures for rows of loudspeaker housings;

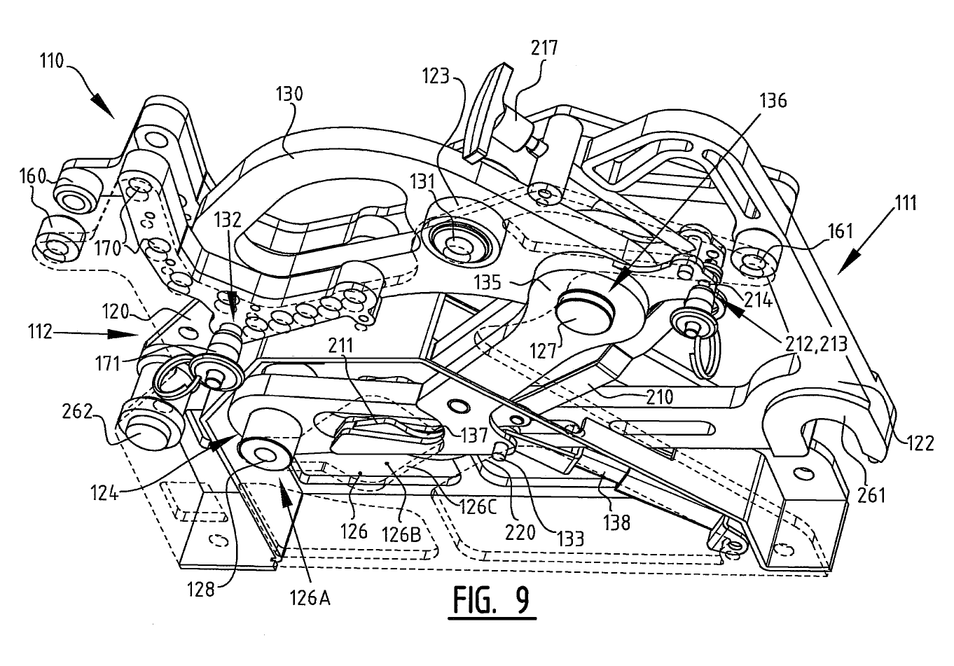

FIG. 9 is a perspective view of a coupling system according to a second embodiment of the invention;

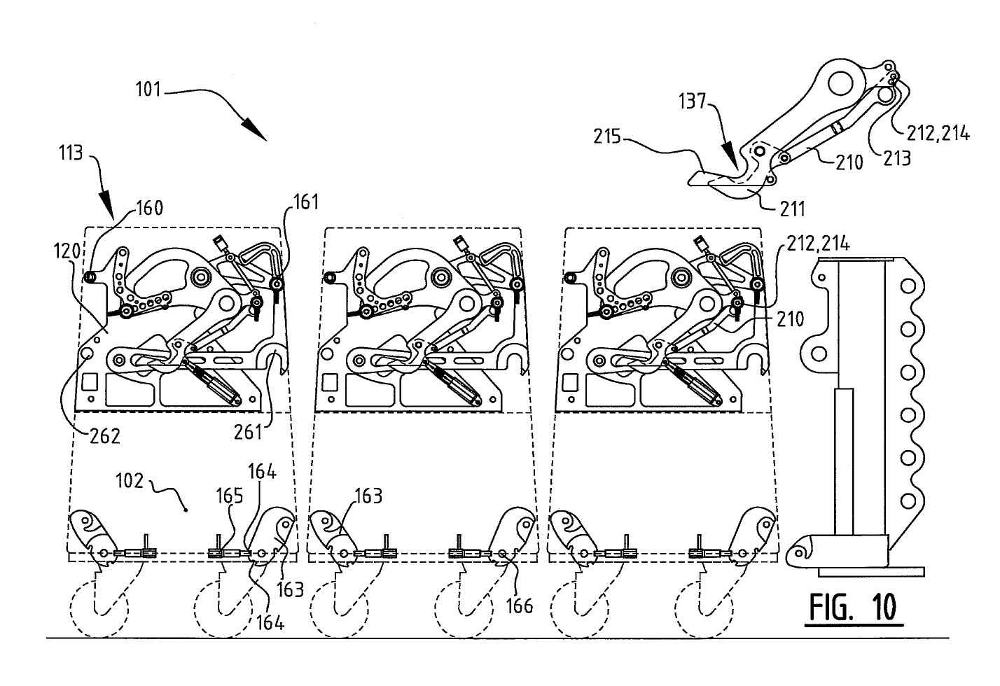

FIG. 10 shows a non-hoisted row of non-coupled loudspeaker housings provided with the coupling system shown in FIG. 9;

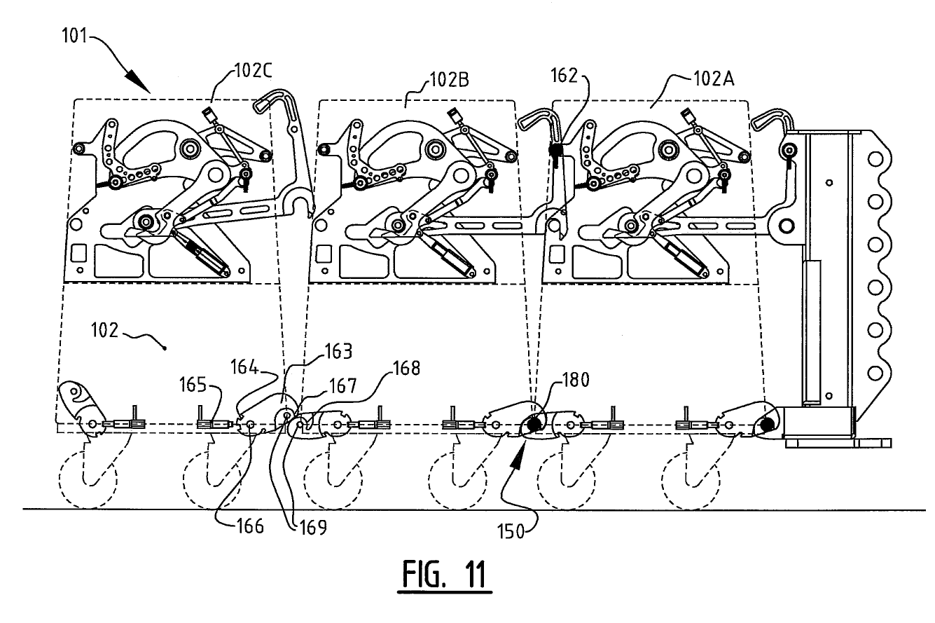

FIG. 11 shows the coupling of the loudspeaker housings of the row shown in FIG. 10;

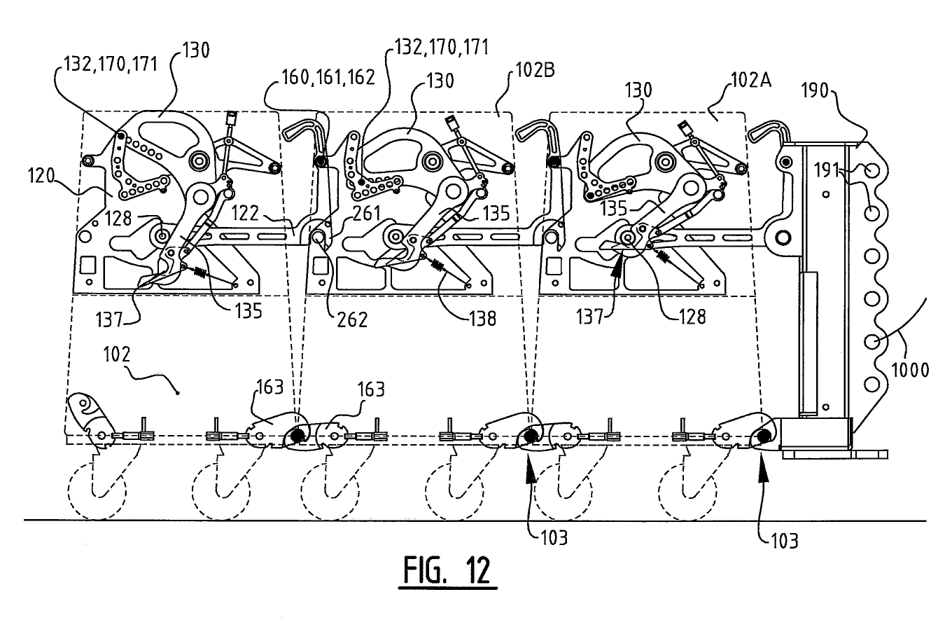

FIG. 12 shows a non-hoisted row of coupled loudspeaker housings provided with the coupling system shown in FIG. 9;

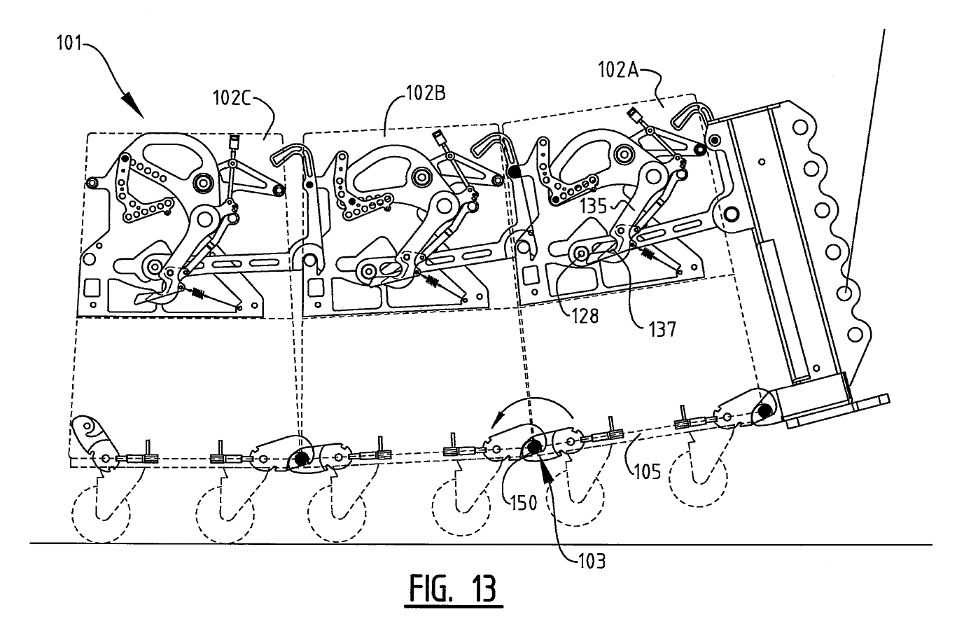

FIG. 13 schematically shows the hoisting of the loudspeaker housings shown in FIG. 12;

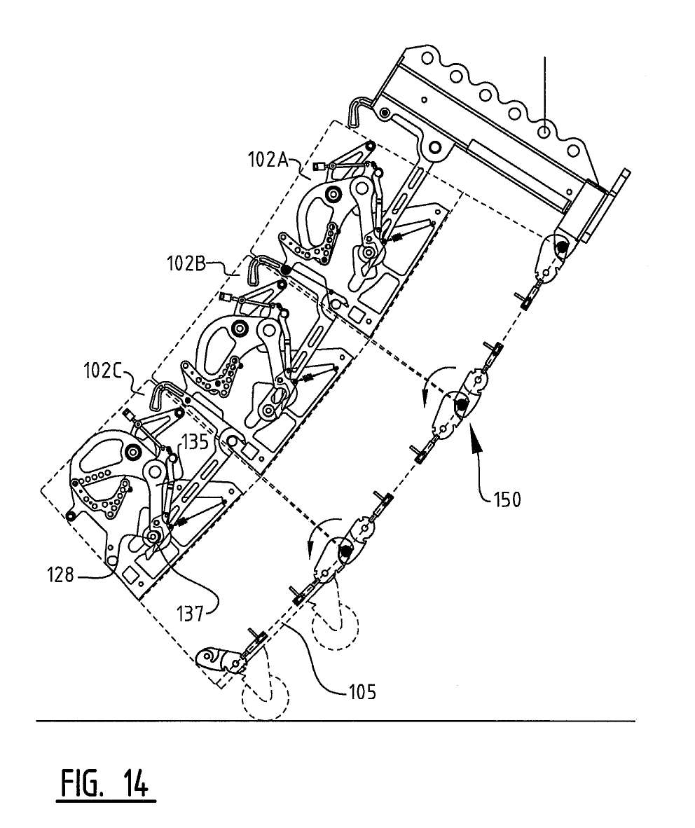

FIG. 14 schematically shows the further hoisting of the loudspeaker housings of FIG. 13;

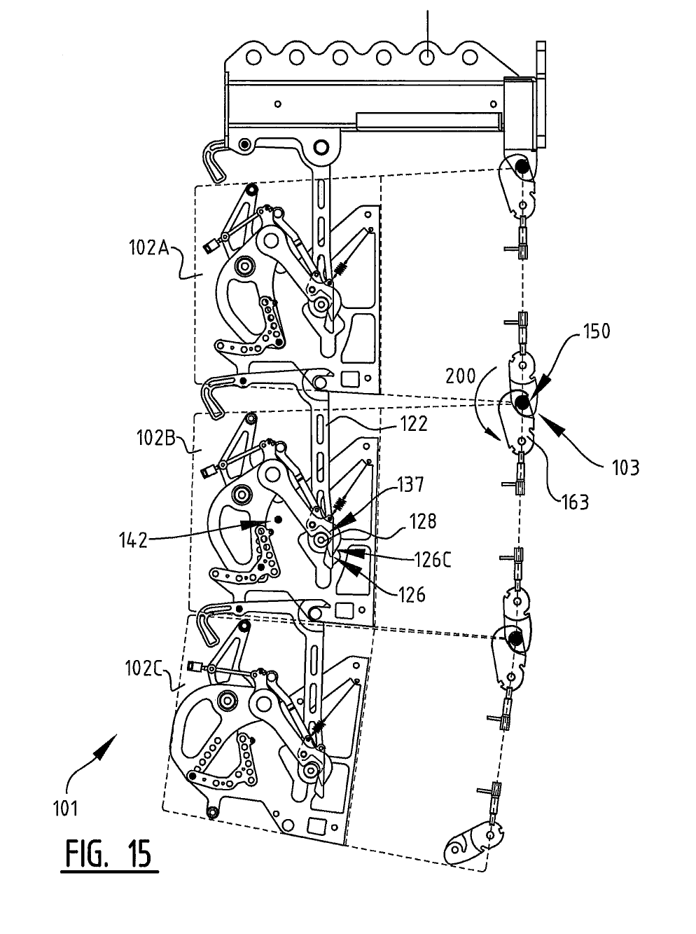

FIG. 15 schematically shows a hoisted row of loudspeaker housings of FIG. 14;

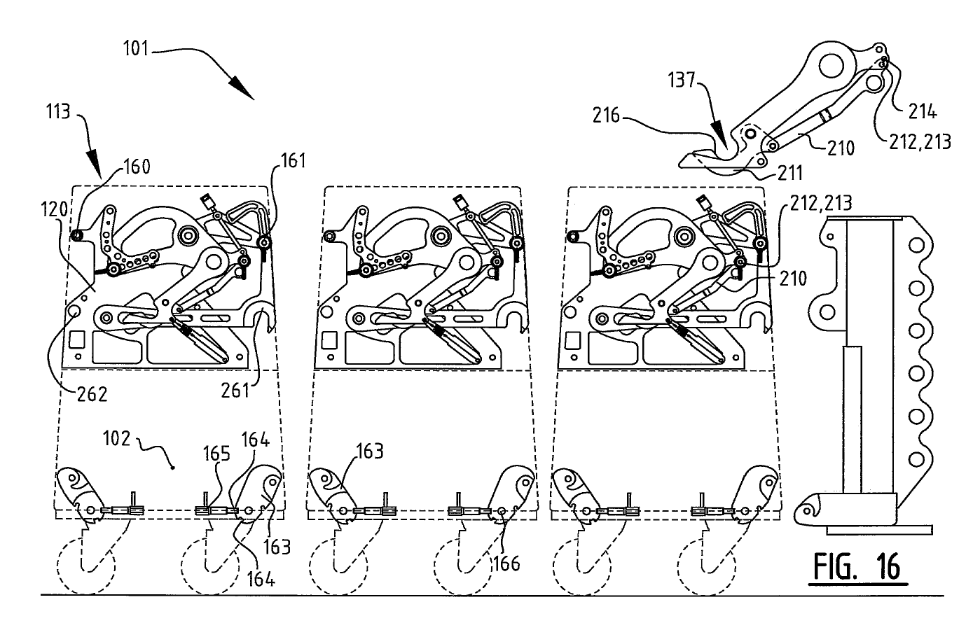

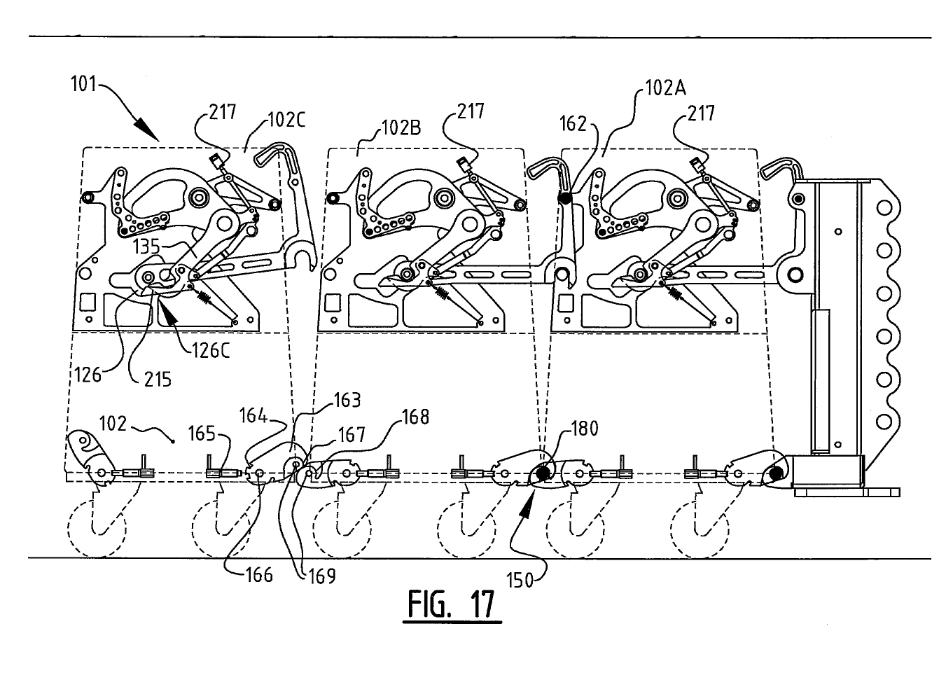

FIG. 16 shows a non-hoisted, row of non-coupled loudspeaker housings;

FIG. 17 shows the coupling of the loudspeaker housings of the row shown in FIG. 16;

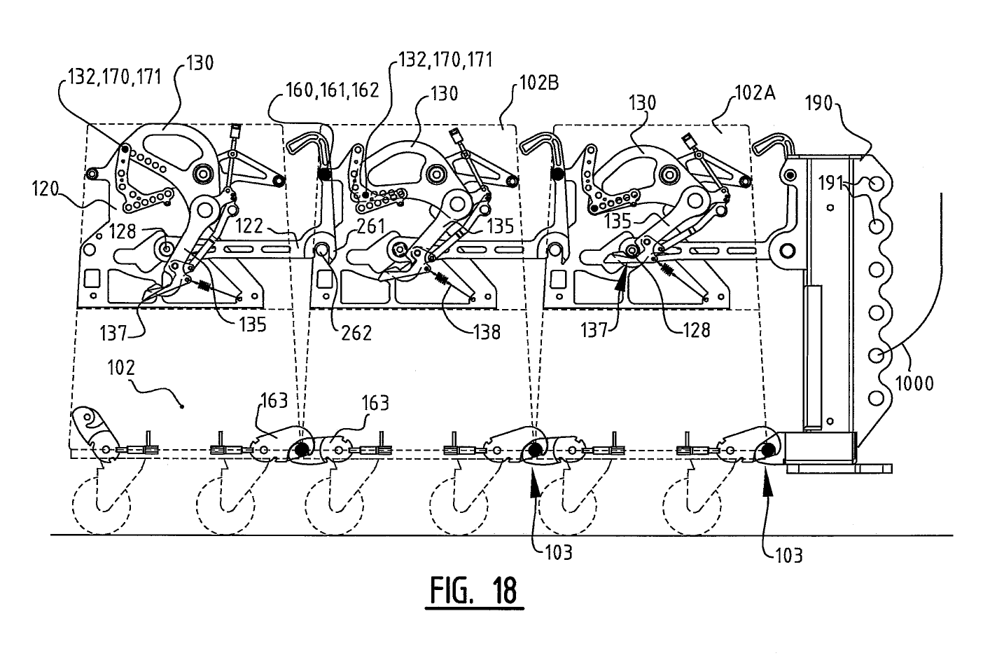

FIG. 18 shows a non-hoisted row of coupled loudspeaker housings provided with the coupling system of FIG. 9 in the second adjusting position;

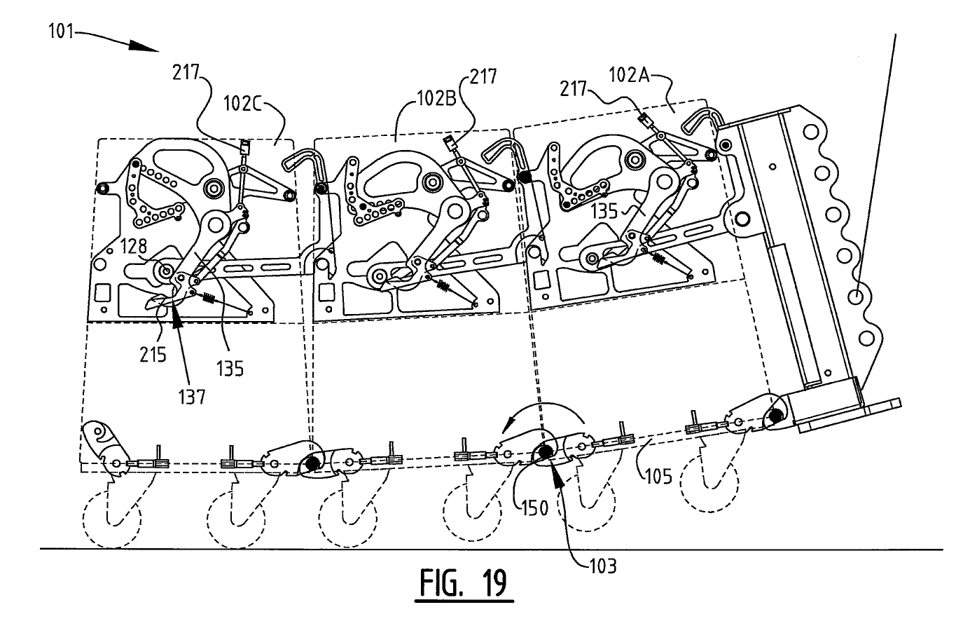

FIG. 19 schematically shows the hoisting of the loudspeaker housings of FIG. 18;

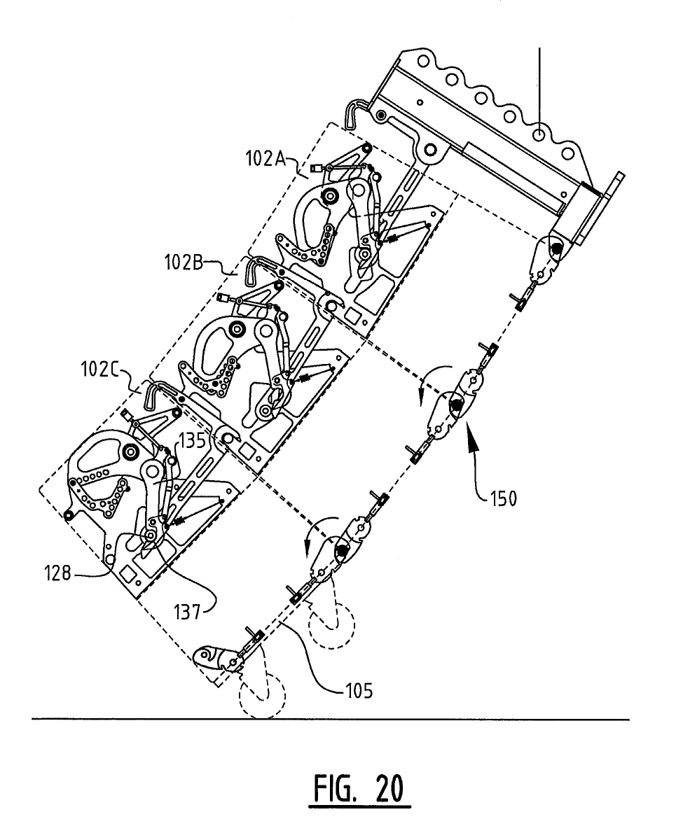

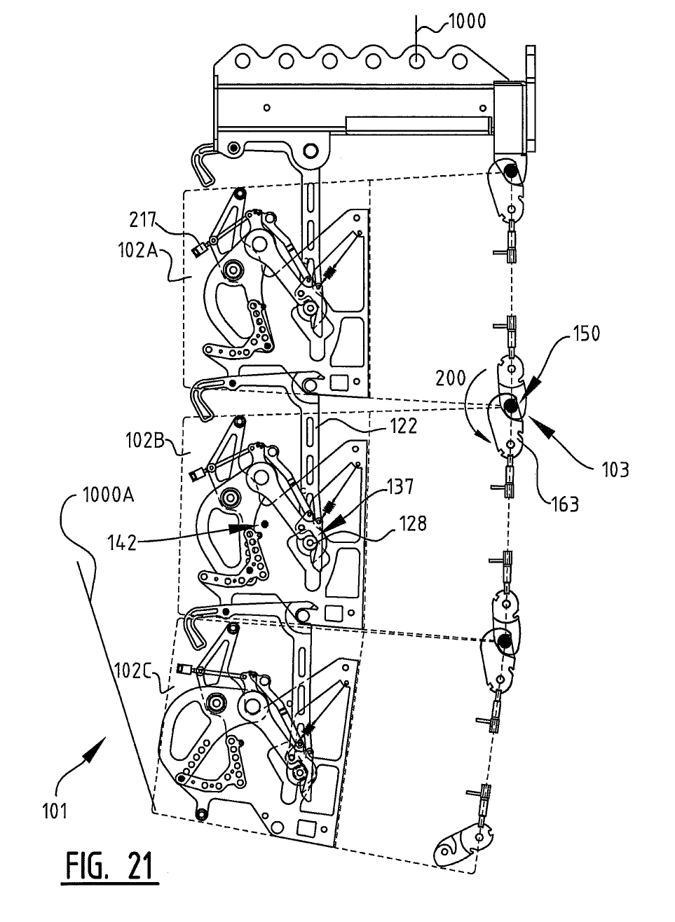

FIG. 20 schematically shows the further hoisting of the loudspeaker housings of FIG. 19; and

FIG. 21 schematically shows a hoisted row of loudspeaker housings of FIG. 20.

FIG. 1 shows a row 1A of loudspeaker housings 2, which comprises at least one loudspeaker, in a hoisted position thereof. In said row, respective loudspeaker housings 2 are disposed vertically below or above next loudspeaker housings 2, with the uppermost loudspeaker housing being suspended from a chain 100, for example. As FIG. 1 shows, the loudspeaker housing 2 is higher at the front side than at the rear side. When a block-shaped loudspeaker housing is used, this shape can be realised by mounting a spacer at the front side. The loudspeaker housings 2 extend vertically at an angle 3 relative to each other, which angle 3 is determined and preset in advance. In the case of large distances, a high sound pressure is important, so that the sound can be clearly heard from a large distance by an audience. To achieve this, the angle 3 between two loudspeaker housings 2 is preferably small, so that the two loudspeakers in the housings will optimally interact. In the case of smaller distances, on the other hand, the sound pressure must be lower, so that a larger angle between two loudspeaker housings 2 is desired, with the maximum angle preferably ranging between 0° and 15°, or between 0° and 6°, depending on the size of the sound system. The presence of said angles 3 appears from FIG. 1, in that the row 1A exhibits a curvature from the top downwards, in the direction of the stage 4.

FIG. 1 furthermore shows a row 1B of loudspeaker housings 2 in half-hoisted condition, which situation can occur both during the hoisting and during the lowering of the row 1 of loudspeaker housings 2. When the loudspeaker housings 2 are being hoisted, a so-called dolly 5, which comprises a plate 6 provided with wheels 7 and which extends against the front side of a loudspeaker 2 in use, is removed from successive loudspeaker housings 2, preferably at man height. When the loudspeaker housings 2 are being lowered, said dollies 5 are, on the contrary, connected to the front side of respective loudspeaker housings 2, so that the loudspeaker housings 2 can rest on the dollies 5.

As appears from FIG. 1, the loudspeaker housings 2 only extend at the predetermined angle 3 in the hoisted condition, with the loudspeaker housings 2 assuming the angular position under the influence of gravity through the use of a coupling system while being hoisted, as will be explained in more detail yet.

FIG. 2 shows a loudspeaker housing 2 wherein a space 13 is provided in the centre of the loudspeaker housing 2, in which space a coupling system 10 is mounted. The space 13 is a through recess which extends from the upper surface to the lower surface of the loudspeaker housing 2, parallel to the lateral surfaces. The upper and lower surfaces are in this case the surfaces against which a next loudspeaker housing 2 extends in the coupled condition. The coupling system 10 comprises coupling means 11 for coupling to loudspeaker housings 2 together and setting means 12 for setting the angle 3 between the two loudspeaker housings 2. The coupling system 10 is shown in detail in FIG. 3, in which a number of parts are shown detached from each other for the sake of clarity. The coupling means 11 comprise a first body 20, two second bodies 21 2/3 bodies 22, which bodies 21, 22 are rigidly connected together. The bodies 21, 22 may also be configured as one single body. The first body 20 is rigidly connected to the loudspeaker housing 2 and is provided with openings 60 designed for connecting the body 20 of a loudspeaker housing 2 to the body 21 of a next loudspeaker housing 2, as will be explained in more detail yet. The first body 20 is further provided with a pin 23, which is designed to function as an axis of rotation for the setting means, as will be explained in more detail yet. The first body 20 is further provided with two keyways 25, 26, in which respective keys 27, 28 are movably provided. The keyway 25 is arcuate in shape and has a centre 50. The keyway 26 comprises a narrow portion 26A, the width of which narrow portion 26A is practically the same as, or preferably slightly greater than, the diameter of the key 28, so that the key 28 can move within the narrow portion 26A along the length of the keyway 26A. The keyway 26 further comprises a widened portion 26B, the width of which wide portion 26B is greater than the diameter of the key 28, so that the key 28 can move both along the length and across the width of the keyway 26B. The bottom side 26C of the wide portion 26B of the keyway 26 is arcuate in shape and has the same centre 50 as the keyway 25. The two third bodies 22 are provided with two circular openings 24 at one end thereof, which circular openings 24 are connected to the key 28 in the keyway 26. The two second bodies 21 are provided with openings 61, which can be connected to the openings 60 in the body 20 of a next loudspeaker housing 2 when the loudspeaker housing 2 is connected to the next loudspeaker housing 2. Said connection is effected by means of bolts 62, for example, which bolts are inserted into the openings 60, 61, so that the bodies 20, 22 will be rigidly connected after the two loudspeaker housings have been coupled together. Preferably, pins connected to the bodies 21, which snap into place in a closure in the body 20, may also be used instead of openings 60, 61 and bolts 62. As FIGS. 2, 3 furthermore show, the coupling means 11 comprise a handle 29 which is rigidly connected to the bodies 21. The handle 29 can be used for rotating the bodies 21, 22, with the bodies rotating about the axis formed by the key 28. This is advantageous in connection with the transport and/or storage of the loudspeaker housings, because the bodies 21, 22 and the handle 29 will be disposed within the loudspeaker housing 2 after having rotated about the key 28. As a result, the bodies 21, 22 and the handle 29 do not project, or less so, so that the loudspeaker housings 2 can be transported or stored more efficiently. When two loudspeaker housings 2 are being coupled together, the handle 29 can be used for rotating the bodies 21, 22 in such a manner that the body 21 can be connected to the body 20 of a next loudspeaker housing 2 by means of bolts 62.

FIGS. 2, 3 further show setting means 12 which comprise a handle 30 provided with openings 31, 32. The openings 31, 32 are rotatably connected to the pin 23 and the key 27, respectively, of the coupling means 11. By rotating the handle 30 about the axis of rotation formed by the pin 23, the key 27 can be moved along the length of the keyway 25 of the first body 20 of the coupling means 11. The setting means 12 further comprise two bodies 35, which are provided with circular openings 36 at one end thereof, which openings are likewise connected to the key 27 in the keyway 25 of the first body 20 of the coupling means 11. The bodies 35 are interconnected by the pin 33 at one end thereof and are each provided, at the same end, with a spring 38 which extends between the bodies 35 and the first body 20, such that the bodies 35 extend at the bottom side of the first body 20, being spring-loaded relative to the first body 20. The bodies 35 are thus rotatably connected to the coupling means 11 about the axis formed by the key 27, with the maximum rotation being limited by the pin 33 that abuts against the body 20 on the one hand and by the maximum length of the springs 38 on the other hand. The bodies 35 are furthermore each provided with a semi-open slot 37, which slots extend in the direction of the first body 20 and which are open on the side of the body 35 that extends towards the first body 20. Said slots 37 are configured to receive the key 28 in the keyway 26, which pin 28 may or may not be positioned in the slots 37 owing to the open configuration of the slots 37. As appears from FIG. 3, the bodies 35 are moved along the length of the body 20 by moving the key 27 in the keyway 25. As a result, the slots 37 move along, as a result of which an angle 3 is set between two loudspeaker housings 2 on account of the fact that the third body 22 of a loudspeaker housing 2 is connected to the key 28 at one end thereof and, on the other hand, to the body 20 of a next loudspeaker housing 2 by means of the body 21. A side of the loudspeaker housing 2 that bounds the space 13 may be provided with a scale 34, by means of which the handle 30 can be fixed in a particular position and by means of which a particular angle 3 is set.

FIG. 4 shows a row 1B of loudspeaker housings 2 in half-hoisted condition. As appears from said figure, the key 28 is not positioned in the slots 37 in the case of the loudspeaker housing 2A that rests on the ground or on the stage 4. Upon further hoisting of the row 1B, the loudspeaker housing 2B will rotate about point 50 in the direction 54, so that the key 28 will move along the length of the bottom side 26C of the keyway 26. Once the key 28 is positioned above the slots 37 in the bodies 35, the key 28 will extend into said openings 37 as a result of the bodies 37 being pulled in the direction of the body 20 by the spring 38. The moment the key 28 is positioned in the slots 37, the angular setting is fixed, but the two loudspeakers 2 do not extend at the angle 3 yet. This will take place when the loudspeaker housings 2 are hoisted up further. When a loudspeaker housing 2D is in a more or less vertical position, it will rotate in the direction 41 under the influence of gravity 40. The reason for this is that the centre of gravity 42 of a loudspeaker housing 2D, or at least the centre of gravity of the row of loudspeaker housings 2 present under the loudspeaker housing 2D, is located behind the keyway 26. Since the body 21 of the loudspeaker housing 2C is rigidly connected to the body 20 of the loudspeaker housing 2D, the loudspeaker housing 2C will move and/or rotate, causing the loudspeaker housings 2C, D to meet at point 50 at their front sides. The same will take place, one by one, for all the loudspeaker housings in the row when said row is hoisted up further, as a result of which the loudspeaker housings 2 will extend at the angle 3 relative to each other, being aligned at point 50, in the hoisted position. Precise alignment of the loudspeaker housings 2 at point 50, which is achieved in an efficient manner by the coupling system, is important in connection with the sound quality. FIG. 4 further shows that the chain 100 may also be connected to the body 21 of the uppermost loudspeaker 2D.

FIG. 5 is a view of a row 1A of loudspeaker housings 2 in hoisted condition, which shows that the loudspeaker housings 2 extend at an angle 3 relative to each other.

FIG. 6 is a detail view of a loudspeaker housing 2, which shows that the key 28 is positioned in the slots 37 and that the loudspeaker housing 2 meets the next loudspeaker housing 2 at an angle 3 at point 50. Since the bodies 35 are connected to the key 27, the distance between the slots 37 and the key 27 will be the same at all times. As a result, the distance from the key 27 to the key 28 will be the same at all times for every angular setting when said key 28 is positioned in the slots 37 of the bodies 35. FIG. 6 furthermore shows the curvature 52 of the keyway 25 with the centre 50 and the curvature 51 of the bottom side 26C of the keyway 26, likewise with the centre 50, which centre 50 is located at the top of the front side of the loudspeaker housing 2. Since the keyway 25 and the bottom side 26C of the keyway 26 have the same centre 50, the keys 27, 28 are moved about the same centre. This has the advantage that the system will behave identically irrespective of the angular setting.

FIG. 7 shows three loudspeaker housings 2 at the moment when said loudspeaker housings touch the ground or a stage 4 upon being lowered. When the loudspeaker housings are being lowered it is important that the angle 3 is automatically cancelled, so that the curvature between the loudspeaker housings 2 is likewise cancelled. As appears from FIG. 7, the loudspeaker housing 2E will rotate in the direction 62 about the point 60 upon making contact with the ground or the stage 4, which point 60 is formed by the location where the wheels 7A touch the ground 4. As a result of said rotation, the body 22 of the coupling means 11 of the loudspeaker housing 2F will likewise rotate in the direction 62 about the point 60, and the key 28 of the coupling means 11 of the loudspeaker housing 2F will rotate along therewith. The rotation of the loudspeaker housings 2E will result in the loudspeaker housing 2F rotating as well, but in this case in the direction 65 about the point 61 at the location of the wheels 7B. As a result, the slots of the bodies 35 of the loudspeaker housing 2F will likewise rotate about the point 61. Since the key 28 rotates about a different point having a different radius than the openings 37, the key will be slightly lifted. As a result, the key 28 will exert a force on the rounded edge 39 (see FIG. 3), causing the bodies 35 to be pushed away from the body 20. As a result, the key 28 will automatically move out of the slots 37. Since the key 28 is no longer positioned within the slots 37, the angle 3 between the loudspeaker housings 2E, 2F is no longer fixed, as is shown for the loudspeaker housings 2F,G in FIG. 7. FIG. 7 further shows that the key 28 of the loudspeaker housing 2G may be temporarily positioned in the narrow portion 26A of the keyway 26, which may temporarily result in a negative angle between the loudspeaker housings 2F,G.

FIGS. 8A,B show the hoisting of loudspeaker housings 2 according to a known system (FIG. 8A) and according to the invention (FIG. 8B). The figures show that the loudspeaker housings take up a stretched position on the ground or the stage 4 as a result of the use of the coupling system 10 (schematically shown). Upon being hoisted, the loudspeaker housings 2 will assume relative positions according to the predetermined angle under the influence of gravity, as has already taken place with the uppermost loudspeaker housings 2 in FIG. 8B, which take up a more or less vertical position. The loudspeaker housings 2 located in the curve between the hoisted, more or less vertical position and the non-hoisted position are not aligned in point 50 at the front side of the loudspeaker housings 2. As a result, the radius of the curve of loudspeaker housings is smaller than with the known systems, as appears from FIGS. 8A,B, so that the row of loudspeaker housings will take up less space upon being hoisted than in known systems. FIG. 8C shows different curvatures of loudspeaker housings 2 in the hoisted position. Depending on the desired sound production, the angles 3 can be set so that said curvatures are realised.

FIG. 9 shows a coupling system 110 according to a second embodiment of the invention. FIGS. 10-21 show loudspeaker housings 102 provided with the coupling system 110, which loudspeaker housings 102 are hoisted at respective angles 103 relative to each other. The coupling system 110 comprises coupling means 111 for connecting two loudspeaker housings 102 together and setting means 112 for setting the angle 103 between the two loudspeaker housings. The coupling means 111 comprise a first body 120 and a second body 122. The first body 120 is rigidly connected to the loudspeaker housing 102. The first body 120 is provided with openings 160 and with a transversely extending pin 262 designed to connect the first body 120 of a loudspeaker housing 102 to a second body 122 of a next loudspeaker housing 102, as will be explained in more detail yet. The first body 120 is further provided with an opening 131, in which a pin 123 can be inserted, which pin is configured to function as an axis of rotation for the setting means 112, as will be explained in more detail yet. The first body 120 is provided with a keyway 126, in which a key 128 is movably provided. The keyway 126 comprises an arcuate bottom side 126C having a centre 150 (see FIG. 11) and has a narrow portion 126A, the width of which narrow portion 126A is practically the same as, or preferably slightly greater than, the diameter of the key 128, so that the key 128 can move along the length of the keyway 126A in said narrow portion 126A. The keyway 126 further has a widened portion 126B, the width of which second portion 126B is greater than the diameter of the key 128, so that the key 128 can move both along the length and across the width of the keyway 126B. The second body 122 is provided with a circular opening 124 at one end thereof, which circular opening 124 is connected to the key 128 in the keyway 126 of the first body 120. At its other end the second body 122 is provided with an opening 161, which opening 161 can be brought into register with the openings 160 in the first body 120 of a next loudspeaker housing 102, in such a manner that a pin or bolt 162 can be inserted into the openings 160, 161 for connecting the two loudspeaker housings 102 together. At its other end, the second body 122 is furthermore provided with a hook-shaped element 261, which can be connected to the pin to 62 of the first body 120 of the next loudspeaker housing 102 for connecting the two loudspeaker housings 102 together. The hook-shaped element 261 engages the pin 262 when said connection is being effected. After the two loudspeaker housings 102 have been coupled together by means of the openings 160, 161 and the bolt 162 and as a result of the hook-shaped element 261 engaging the pin 262, a rigid connection has been effected between the first body 120 of one loudspeaker housing 102 and the second body 122 of the other loudspeaker housing 102. From FIG. 10 it appears that the coupling means 110 are entirely located within the recess 113 of the loudspeaker housing 102 in the transport state of the loudspeaker housing 102.

The coupling means 110 further comprise setting means 112. The setting means 112 comprise a handle 130, which is connected to the opening 131 of the first body 120 by means of a pin 123. The pin 123 forms an axis of rotation, about which the handle 130 can rotate for setting the angle 103 between two loudspeaker housings 102. At one end of the handle 130, said handle 130 is connected to two bodies 135 by means of a pin 127, which pin extends between openings 136 of two bodies 135. The bodies 135 are at one end provided with a pin 133 and with a spring 138, which spring extends between the bodies 135 and the first body 120, such that the bodies 135 are spring-loaded relative to the first body 120. The bodies 135 are thus rotatably connected to the coupling means about the axis formed by the pin 127. The spring 138 exerts a pressure force on the bodies 135, such that said bodies tend to move in the direction of the handle 130. The maximum rotation is limited by the pin 133, which abuts against the edge zone of an opening 220 in the first body 120, on the one hand and by the maximum compression of the spring 138 on the other hand. At the other ends of the bodies 135, said bodies are each provided with a semi-open slot 137, which slots extend in the direction of the handle 130 and which are open on the side of the body 135 that extends towards the handle 130. The slots 137 are configured to receive the key 128 in the keyway 126, and because the slots 137 are open, the key 128 may or may not be positioned in the slots 137. At the other end of the handle 130, said handle 130 comprises an opening 132. The opening 132 can be brought into register with each of the openings 170 in the first body 120 by rotating the handle 130 about the axis of rotation formed by the pin 123. A pin-shaped element 171 can then be inserted into the respective openings 170, 132 so as to connect the handle 130 and the first body 120 for setting the angle 103 between two loudspeaker housings 102. The openings 170 each correspond to a specific angle 103. As a result of the rotation of the handle 130 about the axis of rotation formed by the pin 123 for the purpose of bringing the openings 170 in the first body 120 into register with the opening 132, the first end of the handle 130, and thus also the two bodies 135 connected to the first end of the handle 130, rotates along therewith. This causes the slots 137 in the bodies 135 to move along therewith, making it possible to adjust the position of the key 128 in the slot 137, and since the two loudspeaker housings 102 are interconnected by means of the opening 161 and the hook-shaped element 261 of the second body 122, which is connected to the key 128 on the other side thereof, the angle 103 between the two loudspeaker housings is set. This will be explained in more detail yet.

The coupling system 110 of FIG. 9 further comprises locking elements 210 for adjusting the shape of the slots 137, which locking elements 210 are connected to the two bodies 135. The key 128 may or may not be retained in the slots 137 by means of the locking elements 210, as will be explained in more detail yet. The locking elements 210 are connected to the two bodies 135 by means of retaining bodies 211 at a first end thereof. The locking elements 210 can be connected to the two bodies 135 with their second end via the opening 212. The opening 212 can be brought into register with each of the openings 213, 214 of the two bodies 135 for connecting the locking elements 210 to the two bodies 135 at the correct location, such that the position of the locking elements 210 relative to the two bodies 135 can be set. In FIGS. 10 and 16 the locking elements 210 is shown on a larger scale, separate from the coupling system 110. From the figures it appears that in FIG. 10 the locking elements 210 are connected to the openings 214 of the two bodies 135. In this position the retaining bodies 211 extend in such a manner relative to the slots 137 that the retaining bodies 211 do not limit the shape of the slots 137. One side of the slots 137 is therefore bounded by edge zones 215 of the two bodies 135. In FIG. 16, however, the locking elements 210 are connected to the openings 213 of the two bodies 135, as a result of which the retaining bodies extend in such a manner relative to the slots 137 that the edge zones 216 of the retaining bodies 211 bound one side of the slots. From FIG. 6 it appears that in this position the key 128 can be retained in the slots 137, whilst in the position shown in FIG. 10 the key 128 can move freely over the edge zone 215. From FIGS. 10 and 16 it furthermore appears that the key 128 is at all times retained in the slots 137 relative to the other side of the slot 137, independently of the position of the retaining bodies 211. The position of the retaining bodies 211 relative to the slots 137, and thus the retainment or non-retainment of the key 128 in the slots 137, determines the rotational freedom relative to each other of the loudspeaker housings 102, as will be explained in more detail yet. A handle 217 is likewise connected to the two bodies 135, in such a manner that the bodies 135 can be pushed aside against the spring pressure of the spring 138 by exerting a pulling force on the handle 217, so that the key 128 can move out of the slots 137.

FIG. 10 shows a row 101 of loudspeaker housings 102 in non-hoisted, non-coupled condition. Each loudspeaker housing 102 comprises a connecting body 163 at both ends for connecting the loudspeaker housing 102 to a next loudspeaker housing 102. The loudspeaker housings 102 can therefore be connected at three locations, viz. near the respective openings 160, 161, near the pin 262 or the hook-shaped element 261, and near the connecting bodies 163. The connecting bodies 163 are provided with two slots 164 at one end thereof. A stop bolt 165 extends into one of said slots in each case for locking the connecting body 163 in position at a particular angle. As appears from FIG. 10, the connecting bodies 163 can thus be fixed in such a manner that they extend within the loudspeaker housing 102. As appears from FIG. 11, removal of the stop bolt 165 from one slot 164 enables the connecting body 163 to rotate about an axis 166 for connecting the connecting body 163 to another connecting body 163 of a next loudspeaker housing 102. A claw-shaped end 167 of a connecting body 163 can extend into a respective claw-shaped slot 168 of a next connecting body 163. Respective openings 169 of the connecting bodies 163 are in this way brought into register with each other, such that a locking pin 180 can be inserted into the openings 169 for connecting the two connecting bodies 163. From FIG. 11 it furthermore appears that the key 128 will move into the slots 137 when the loudspeaker housings are coupled together. FIG. 12 shows the three loudspeaker housings 102 being coupled by means of the connecting bodies 163 as well as by means of the first body 120 and the second body 122, with the hook-shaped element 261 of the second body 122 engaging the pin 262 of the first body 120 of the next loudspeaker housing 102, and with the opening 161 of the second body 122 being connected, via a pin 162, to an opening 160 of the first body 120 of the next loudspeaker housing 102. As appears from FIG. 12, the front loudspeaker 102A is connected to a hoisting element 190 in a similar manner. The hoisting element 190 is provided with a number of openings 191 for connecting said openings 191 to a cord 1000. In this way the row of loudspeaker housings 102 can be hoisted at the desired locations.

FIG. 12 further shows the setting of the angle between the loudspeaker housings 102. As appears from FIG. 12, the first body 120 is in register with the opening 132 of the handle 130 with one of its openings in each case, whilst a pin 171 is inserted into the openings 170, 132. As appears from FIG. 12, the bodies 135 of the various loudspeaker housings 102 extend at different positions in each case, with the position of the slot 137 corresponding to the set angle 103. When the loudspeaker housings 102 are in the stretched, non-hoisted position, the key 128 will only extend into the slot 137 if the angle 103 is set at 0°. Said minimum angle of 0° is for example set between the frontmost loudspeaker housing 102A and the hoisting element 190, and it is clear that the key 128 is already positioned in the slot 137 of the body 135 in the non-hoisted position. If the angle is larger than 0°, the key 128 will not extend into the slot 137 in the stretched position. This is possible because the bodies 135 are manually pushed aside by means of the handle 217, such that the key 128 can move out of the slots 137. As a result, the loudspeaker housings do not extend at the set angle 103 in the stretched position. From FIG. 12 it appears that the key 128 pushes the bodies 135 aside against the pressure forces of the spring 138.

FIGS. 13 and 14 show the hoisting of the row 101 of loudspeaker housings 102. As appears from these figures, the loudspeaker housings 102 rotate about the rotation point 150 upon being hoisted, during which hoisting the angle 103 between the loudspeaker housings increases, such that the curve of the row 101 will be minimal. If a maximum angle 103 is set between two loudspeaker housings 102, as is the case between the loudspeaker housings 102B and 102C, the key 128 will extend at the maximum angle 103 into the slots 137. If the set angle 103 is smaller than the maximum angle, as is for example the case between the loudspeaker housings 102A and 102B, the key 128, on the contrary, will not extend into the slots 137 but push aside the bodies 135. This is possible because the slots 137 are not bounded by the retaining bodies 211, as a result of which the key can freely move over the edge zone 215 of the slots 137, enabling it to push the two bodies 135 aside. Since the keys 128 of the loudspeaker housings 102A, 102B do not extend into the slots 137 when the loudspeaker housings are being hoisted, said loudspeaker housings 102 can extend at the maximum angle 103 during said hoisting, as described in the foregoing. As furthermore appears from FIG. 14, the dollies 105 of the loudspeaker housings 102A, 102B have been removed. The dolly 105 of the loudspeaker housing 102C can be removed after the row 101 has been hoisted up further.

FIG. 15 shows the row 101 of loudspeaker housings 102 in the fully hoisted condition of said row. As appears from FIG. 15, the keys 128 of each of the loudspeaker housings 102A, 102B, and 102C extend into the respective slots 137, so that the loudspeaker housings 102 extend at the set angle 103 relative to each other. The movement of the loudspeaker housings 102 to the set angle 103 takes place under the influence of gravity. For example, the loudspeaker housing 102B rotates in the direction 200 about the rotation point 150 because the centre of gravity 142 of the loudspeaker housing 102B, or at least of the row 101 of loudspeaker housings 102, is located behind the keyway 126. As a result, the key 128 of the loudspeaker housing 102B will move over the arcuate bottom side 126C of the keyway 126 until it is positioned over the slot 137 and the key 128 extends into the slots 137. At that point the loudspeaker housing 102B extends at the correct angle relative to the loudspeaker housing 102A. It is noted that the loudspeaker housing 102A already extends at the set angle 103 relative to the hoisting element 190 while being hoisted, as appears from FIG. 14, in which the key 128 extends into the slot 137. Also the loudspeaker housing 102C already extended at the set angle 103 relative to the loudspeaker housing 102B while being hoisted, because said angle 103 is set at a maximum value, as described above.

It is noted that in this second embodiment the loudspeaker housings 102 are connected in the region of the centre of the keyway 126 by connecting bodies 163. In this way a correct alignment of the loudspeaker housings 102 in the centre 150 is realised in a simple manner.

The lowering (not shown) of the loudspeaker housings 102 can take place in a simple manner in that the loudspeaker housings 102 will rotate about the rotation point 150 upon making contact with the ground whilst the angle 103 between the loudspeaker housings will increase, such that the curvature of the row 101 will be minimal. This is possible in that the keys 128 can move out of the slots 137 and push the bodies 135 aside. The pin 171 is removed from the openings 170, 135 when this takes place, so that the angular setting is cancelled. The loudspeaker housings 102 will take up a stretched position again after being lowered. It will be understood that the dollies 105 will be provided again before the loudspeaker housings 102 make contact with the ground.

FIGS. 16-21 show the hoisting of the row 101 of loudspeaker housings 102 when the locking elements 210 are connected to the openings 213 of the two bodies 135. As described in the foregoing, the shape of the slots 137 is thus bounded to such an extent that the key 128 can be retained in the slots 137.

In FIG. 17 the coupling of the row 101 of loudspeaker housings 102 is shown. Because the key 128 can freely move over the edge zone 215 for pushing aside the two bodies 135 in this locked position, the two bodies 135 must be pushed aside manually by means of the handle 217. Because the two bodies 135 are manually pushed aside, the key 128 can move over the arcuate bottom side 126C of the keyway 126 until the key 128 is positioned above the slots 137. At that moment the pulling forces on the handle 217 can be released, so that the key 128 will extend into the slots 137. As FIG. 17 shows, the pulling forces on the handle 217 of the loudspeaker housings 102A, 102B has already been released, whilst the is exerted on the handle 217 of the loudspeaker housing 102C. Coupling further takes place in the same manner as described above with reference to FIG. 11.

In FIG. 18 the setting of the angle 103 between two loudspeaker housings 102 is shown, which setting takes place in an identical manner as described with reference to FIG. 12.

The hoisting of the row 101 of loudspeaker housings 102 is shown in FIGS. 19 and 20. During said hoisting, must be exerted on the handle 217 for pushing the two bodies 135 aside so as to enable the key 128 to move out of the slots 137, such that the relative angle 103 between two loudspeaker housings 102 can increase in order for the row 101 to be hoisted with a small curvature. Said pushing aside of the two bodies 135 cannot be effected automatically by the force that the key 128 exerts on the two bodies 135, because the key 128 is retained in the slots 137 and cannot move freely over the edge zone 215 of the slots 137. Once the maximum angle 103 between two loudspeaker housings 102 has been reached, the pulling force on the handles 217 can be released. The loudspeaker housings 102 can now rotate relative to each other under the influence of gravity so as to move to the set angle 103, as has been described in the foregoing. The removal of the dollies 105 takes place in the manner described in the foregoing.

FIG. 21 shows the row 101 of loudspeaker housings 102 in hoisted condition. As FIG. 21 shows, the keys 128 of each of the loudspeaker housings 102A, 102B, 1020 extend into the respective slots 137, so that the loudspeaker housings 102 extends at the set angle 103 relative to each other. The movement of the loudspeaker housings 102 to the set angle 103 has taken place under the influence of gravity, as has been described above with reference to FIG. 15, during which movement the pulling force on the handle 217 was released, as has been described in the foregoing with reference to FIG. 20. Since the keys 128 of the loudspeaker housings 102 are retained in the slots 137, the loudspeaker housings cannot rotate relative to each other. This makes it possible to connect a second cord 1000A to the loudspeaker housing 102C, such that the row 101 of loudspeaker housings 102 can be suspended near both ends, without the Loudspeaker housings 102 rotating relative to each other. Suspending the row 101 of loudspeaker housings 102 in this manner can be advantageous when a relatively long row 101 comprising a relatively large number of loudspeaker housings 102 exhibiting a relatively large curvature is formed. In the situation that is shown in FIG. 15 is not possible to suspend the row 101 in this manner with two cords 1000 connected to both ends of the row 101, because the keys on 28 will in that case push the bodies 135 aside, as a result of which the loudspeaker housings 102 will rotate relative to each other to a maximum relative angle 103.

The lowering (not shown) of the loudspeaker housings 102 can take place in a simple manner by making use of the handle 217 again. Said lowering will take place in the same manner as described above in that case.

It is noted that the invention is not limited to the embodiments discussed in the foregoing, but that it also extends to other variants that fall within the scope of the appended claims. Thus, a coupling system may be used which is provided on both sides or on the rear side of a loudspeaker housing. According to another possibility, the openings 24 of the two further bodies 22 can be connected to the key 28 of a next loudspeaker housing 2 for realising a connection between two loudspeaker housings 2, with the bodies 20, 21, 22 being rigidly connected or being configured as one body.

1. A coupling system for coupling at least two loudspeaker housings, comprising coupling means designed for coupling the two loudspeaker housings together, which coupling system is designed to couple the loudspeaker housings in such a manner that the loudspeaker housings will extend at a predetermined angle relative to each other in a hoisted position, and which comprises setting means for setting said predetermined angle, wherein the setting means are designed for setting the predetermined angle when the loudspeaker housings are in a non-hoisted, stretched position, and wherein the coupling system is further designed for coupling the loudspeaker housings in such a manner that said loudspeaker housings, upon being moved from the non-hoisted position to the hoisted position, will move under the influence of gravity from the stretched position to the position in which the loudspeaker housings extend at said predetermined angle.

2. The coupling system according to claim 1, wherein the coupling system is further designed for coupling the loudspeaker housings such that said loudspeaker housings can move from the position in which the loudspeaker housings extend at said predetermined angle to the stretched position upon being moved from the hoisted position to the non-hoisted position.

3. The coupling system according to claim 1, wherein the coupling means are designed for being movably connected at one end to another end of next coupling means, wherein the setting means comprise retaining means for retaining, in the hoisted position, the coupling means at a position on the other end of the next coupling means which corresponds to the predetermined angle, and wherein the retaining means are designed for retaining the couplings means, at said position on the other end of the next coupling means after rotation of the loudspeaker housings in a direction away from each other.

4. The coupling system according to claim 3, wherein said next coupling means are provided with a guide at the other end, in which guide a fastening device is movably provided, which fastening device is designed for being connected to one end of the coupling means, and wherein the retaining means are designed for retaining the fastening device at a particular position in the guide corresponding to the predetermined angle in the hoisted position.

5. The coupling system according to claim 4, wherein said guide comprises a keyway and said fastening device comprises a key.

6. The coupling system according to claim 4, wherein one end of the coupling means comprises at least one opening for receiving the fastening device of the next coupling means.

7. The coupling system according to claim 3, wherein the retaining means comprise at least one opening for receiving the fastening device, which fastening device is retained at a particular position in the guide when it is present in the opening.

8. The coupling system according to claim 7, wherein the retaining means further comprise bounding means for bounding the opening, which bounding means are movable between a first position, in which the opening is not bounded, and a second position, in which the opening is bounded, such that the fastening device, when present in the opening, can move out of the opening in the first position as a result of a force being exerted thereon, whilst it is retained in the opening in the second position.

9. A loudspeaker housing which is higher at the front side than at the rear side, comprising a recess which continues from the upper side to the bottom side, which recess is located in a centre plane of the loudspeaker housing which extends perpendicularly to the front, rear, upper and bottom sides, in which recess a coupling system is provided for coupling the loudspeaker housing to another identical loudspeaker housing.

10. The loudspeaker housing according to claim 9, comprising a coupling system which comprises coupling means for connecting the loudspeaker housing to another identical loudspeaker housing, wherein the coupling means comprise two bodies, wherein the first body is rigidly connected to the loudspeaker housing, comprising a guide in which a fastening device is movably provided, which guide is at least partially arcuate in shape, having a centre which is located at the top Or the bottom of the front side of the loudspeaker housing, wherein the fastening device is connected to an end of the second body, wherein the loudspeaker housing or the first body is designed to be connected to the other end of the second body of the other, identical loudspeaker housing, wherein the coupling system comprises setting means for setting a predetermined angle between the loudspeaker housing and the other, identical loudspeaker housing, and wherein the setting means comprise retaining means for retaining the fastening device at a particular position in the guide which corresponds to the predetermined angle.

11. The loudspeaker housing according to claim 10, wherein the second body is movably connected to the first body, such that the second body can be disposed substantially in the recess within the envelope of the loudspeaker housing.

12. The loudspeaker housing according to claim 10, wherein the first body comprises a number of openings that correspond to a specific angle between the loudspeaker housing and the other identical loudspeaker housing wherein the retaining means can be connected to each of said number of openings with one end, such that the position of the retaining means relative to the first body can be adjusted for setting the predetermined angle.

13. The loudspeaker housing according to claim 10, wherein the loudspeaker housing comprises connecting means for connecting a loudspeaker housing to the other identical loudspeaker housing in the centre.

14. A method for hoisting and lowering loudspeaker housings, comprising the steps of adjusting means for determining an angle between two loudspeaker housings in a hoisted position whilst the loudspeaker housings are in a stretched, non-hoisted position, moving loudspeaker housings between the non-hoisted position and the hoisted position, wherein the loudspeaker housings, upon being moved from the non-hoisted position to the hoisted position, will move relative to each other under the influence of gravity from the stretched position to the position in which the loudspeaker housings extend at the set angle.

15. The method according to claim 14, wherein said movement relative to each other from the stretched position to the position in which the loudspeaker housings extend at the set angle takes place as a result of rotation of the loudspeaker housings relative to each other under the influence of gravity.
